(19) United States
(12) Patent Application Publication
(10) Pub. No.: US 2026/0178698 A1
(43) Pub. Date: Jun. 25, 2026

(54) SYSTOLIC ARRAY MATRIX-MULTIPLY ACCELERATOR WITH ROW TAIL ACCUMULATION

(71) Applicant: Akeana, Inc, Santa Clara, CA (US)

(72) Inventors: David Cureton Baker, Austin, TX (US); David St Clair Scott, Portland, OR (US)

(73) Assignee: Akeana, Inc., Santa Clara, CA (US)

(21) Appl. No.: 19/424,486

(22) Filed: Dec. 18, 2025

Related U.S. Application Data
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.
(60) Provisional application No. 63/914,824, filed on Nov. 10, 2025.

(51) Int. Cl. G06F 17/16

(52) U.S. Cl. CPC G06F 17/16

(57) ABSTRACT

An accelerator is accessed. The accelerator includes a systolic array of tiles that include a plurality of rows and a plurality of columns. Each tile in the systolic array of tiles includes one or more multiply-add units. The accelerator includes a row tail associated with each row within the plurality of rows. A first matrix is multiplied by a second matrix in the systolic array. The multiplying is based on a plurality of partial products. A row within the plurality of rows of the systolic array produces one or more partial products within the plurality of partial products. A last tile within the row forwards the one or more partial products to an associated row tail. The one or more partial products that were forwarded are accumulated with one or more previous partial products associated with the row by the associated row tail.

### RELATED APPLICATIONS

This application claims the benefit of U.S. provisional patent applications “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, “Matrix Multiply Acceleration Based On A Static Partitioning History Table” Ser. No. 63/914,824, filed Nov. 10, 2025, and “Hierarchical Performance-Based Scheduler For Data Center Workloads” Ser. No. 63/941,793, filed Dec. 16, 2025.

Each of the foregoing applications is hereby incorporated by reference in its entirety.

### FIELD OF ART

This application relates generally to matrix processing and more particularly to a systolic array matrix-multiply accelerator with row tail accumulation.

### BACKGROUND

Computer processors have become essential in a wide range of applications, from traditional fields like finance and manufacturing to emerging areas such as artificial intelligence (AI) and autonomous vehicles. In traditional sectors, processors can handle tasks such as data processing, automation control, and financial modeling, where they ensure accuracy, speed, and efficiency in large-scale computations. For example, in banking, processors can enable high-frequency trading systems, which can execute trades in milliseconds by processing complex algorithms. Similarly, manufacturing can use processors in programmable logic controllers (PLCs) to monitor and control assembly lines, increasing precision and productivity. Processors now power devices and applications that are used by millions of people on a daily basis, from smartphones and medical diagnostics to smart home devices and beyond. As processors continue to evolve, they drive innovation across industries, pushing the boundaries of what computers can achieve in both established and emerging fields.

In recent years, artificial intelligence (AI) has become significantly more accessible due to advances in user-friendly AI frameworks, the growth of cloud-based AI services, and the release of open-source models and tools. The increased access to AI has led to an “AI democratization” that has spurred innovation across industries, allowing startups, educators, and small businesses to integrate AI into their products and services. This has resulted in more customized consumer experiences, improved automation, and advancements in fields such as healthcare and education. Additionally, cloud services from providers such as Google Cloud, Amazon Web Services (AWS), and Microsoft Azure offer pre-built AI models for tasks such as image recognition, natural language processing, and speech-to-text. These services can make AI accessible even to smaller companies and independent developers. For instance, smaller healthcare providers can now use AI for diagnostic assistance, and educators can implement personalized learning tools for students without the need for large school budgets.

AI is being harnessed for a wide variety of beneficial applications across industries, delivering value in ways that were previously not possible. For example, machine learning models can analyze medical images, such as X-rays or MRIs, to detect diseases such as cancer and neurological conditions with a high degree of accuracy, often supplementing or accelerating doctors'analyses. AI also can power predictive analytics, which can help healthcare providers anticipate patient outcomes and tailor their treatments. Chatbots and virtual health assistants can provide preliminary consultations, reducing the burden on healthcare staff. In the financial sector, AI can play a role in fraud detection, risk management, and customer service. Machine learning algorithms can monitor transaction patterns and detect anomalies that indicate fraud. AI can also be used in credit scoring by analyzing non-traditional data points, potentially making credit accessible to a broader population. Chatbots and automated financial advisors help customers manage their finances, providing services such as investment guidance and budget tracking. The adoption of AI in these, as well as other diverse fields, is enhancing efficiency, accessibility, and personalization while driving innovation and sustainability.

### SUMMARY

As AI continues to evolve and becomes more integrated into everyday applications, the demand for more powerful and efficient processing hardware has grown. Traditional processors, while adequate for general-purpose computing, are often not optimized for the parallel processing demands and specialized calculations that AI workloads require. To support these needs, advancements in processors, coprocessors, and dedicated hardware are necessary. AI models, especially deep learning models, require extensive calculations, often involving large matrix operations and massive parallelism. Traditional CPUs are not optimized for this level of parallelism and can struggle to deliver required performance without significant power consumption. Disclosed implementations are based on an AI accelerator that can be used to handle some of these tasks more efficiently, reducing energy costs and enabling faster processing.

A systolic array matrix-multiply accelerator with row tail accumulation is disclosed. The systolic array can be a weight-stationary systolic array. An accelerator core is coupled to a processor via a shared memory architecture, such as a level 2 (L2) cache. A weight matrix and one or more activation matrices are loaded into the L2 cache. The accelerator core includes a circular buffer to receive work requests. The work requests include instructions for performing matrix operations such as matrix multiplications, multiply-accumulate operations, and so on. The accelerator core generates an answer matrix, where the answer matrix is the result of a matrix operation. The accelerator core signals the processor that the result is available.

A processor-implemented method for matrix processing is disclosed comprising: accessing an accelerator, wherein the accelerator includes a systolic array of tiles comprising a plurality of rows and a plurality of columns, wherein each tile in the systolic array of tiles comprises one or more multiply-add units, and wherein the accelerator includes a row tail associated with each row within the plurality of rows; multiplying, by the systolic array, a first matrix by a second matrix, wherein the multiplying is based on a plurality of partial products, and wherein a row within the plurality of rows of the systolic array produces one or more partial products within the plurality of partial products; forwarding, by a last tile within the row, to an associated row tail, the one or more partial products; and accumulating, by the associated row tail, the one or more partial products that were forwarded, with one or more previous partial products associated with the row. Some embodiments comprise matching the associated row tail with an answer buffer. In embodiments, the answer buffer that was matched with the associated row tail comprises two or more static random-access memory (SRAM) banks. In embodiments, each SRAM bank within the two or more SRAM banks includes a single port. In embodiments, the answer buffer is capable of reading and writing on a single clock cycle.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a systolic array matrix-multiply accelerator with row tail accumulation.

FIG. 2 is a flow diagram for saving a final answer.

FIG. 3 is an infographic for a systolic array matrix-multiply accelerator with row tail accumulation.

FIG. 4 is a block diagram of a systolic array matrix-multiply accelerator with row tail accumulation.

FIG. 5 is a block diagram of a systolic array.

FIG. 6 is a block diagram of staggered execution.

FIG. 7 is a first block diagram of row tail function.

FIG. 8 is a second block diagram of row tail function.

FIG. 9 is a third block diagram of row tail function.

FIG. 10 is a fourth block diagram of row tail function.

FIG. 11 is a fifth block diagram of row tail function.

FIG. 12 is a sixth block diagram of row tail function.

FIG. 13 is a seventh block diagram of row tail function.

FIG. 14 is a system diagram for a systolic array matrix-multiply accelerator with row tail accumulation.

### DETAILED DESCRIPTION

Matrices play a foundational role in machine learning because they can provide a structured way to represent data and perform the large-scale calculations that many algorithms require. For example, in neural networks, data can be processed as a series of matrix multiplications as it moves through layers of weights and biases. Training and inferencing involve repetitive and computationally intense operations, such as matrix multiplication and multiply-accumulate (MAC) computations. These operations can be used to create weights for the neural network during training and to calculate activations during inference. Efficient hardware for matrix operations, especially hardware designed for matrix multiplication and multiply-add operations, is crucial in accelerating AI. Traditional CPUs, even those with dedicated “vector units,” have proven to be insufficient, especially for larger workloads. For example, a CPU with a dedicated vector unit can perform single instruction multiple data (SIMD) operations. These CPUs can operate on portions of data stored in a vector register (or multiple vector registers) simultaneously. However, AI workloads can demand a higher level of parallelism and bandwidth than can be provided by a single unit or group of units integrated into a processor core. Disclosed implementations provide an accelerator that is well suited for handling matrix operations with high efficiency by performing multiple pipelined multiply-add operations simultaneously, thus accelerating training and inferencing of large machine learning models.

A systolic array matrix-multiply accelerator with row tail accumulation is disclosed. An accelerator is accessed. The accelerator includes a systolic array of tiles. The systolic array of tiles comprises a plurality of rows and a plurality of columns. Each tile in the systolic array of tiles comprises one or more multiply-add units. The accelerator includes a row tail associated with each row within the plurality of rows. A first matrix is multiplied by a second matrix by the systolic array. The multiplying is based on a plurality of partial products. A row within the plurality of rows of the systolic array produces one or more partial products within the plurality of partial products. A last tile with the row forwards the one or more partial products to an associated row tail. The one or more partial products that were forwarded are accumulated, by the row tail, with one or more previous partial products associated with the row. The associated row tail can be matched with an answer buffer. The accumulating can include prefetching the one or more previous partial products associated with the row from the answer buffer, by the associated row tail. One or more previous partial products can be forced to zero. The forcing can be based on one or more control bits. A result of the accumulating can be stored by the associated row tail. The storing can be accomplished by the answer buffer. A work request from a processor core can be received by the accelerator. The work request can include the first matrix and the second matrix. The work request can be based on an execution of a machine learning model. The systolic array can be a weight-stationary systolic array. The first matrix can be a weight matrix, and a second matrix can be an activation matrix. Once the weight matrix is multiplied by the activation matrix, the weight matrix can remain within the multiply-add circuits while a new activation matrix is loaded for the next multiplication. In this way, the weights can remain “stationary” while new activations are loaded into the array.

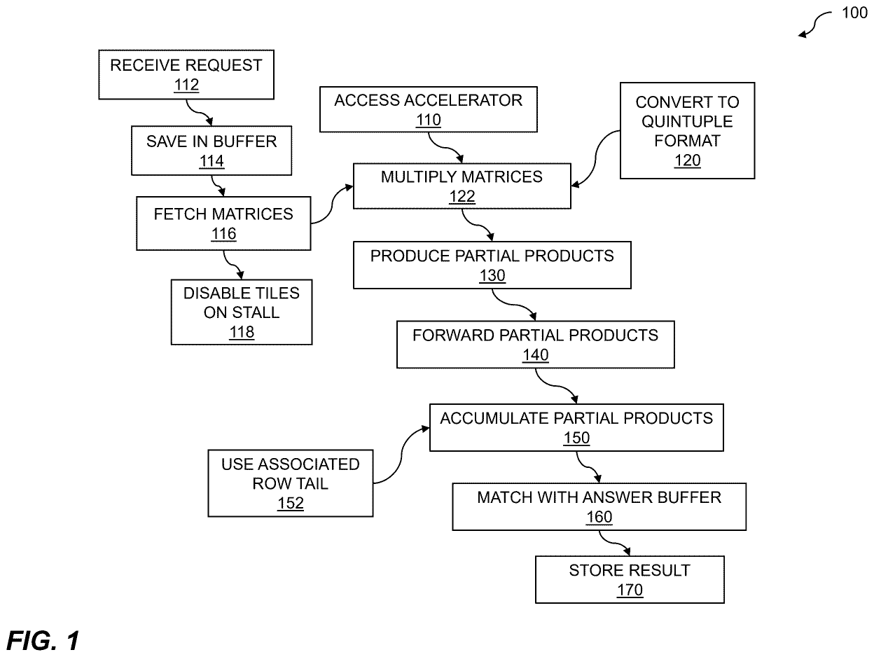

FIG. 1 is a flow diagram for a systolic array matrix-multiply accelerator with row tail accumulation. The flow 100 includes accessing an accelerator 110. The accelerator core can be included on a multi-processor chip, an application specific integrated circuit (ASIC), a system-on-a-chip (SOC), as a separate integrated circuit (IC), and so on. The accelerator is coupled to a memory hierarchy. The memory hierarchy can include L1, L2, L3, etc. caches. The memory hierarchy can include memory such as DRAM, SDRAM, and so on. The memory hierarchy can be coherent or non-coherent. The shared memory architecture can be tightly coupled to the accelerator. The accelerator includes a systolic array of tiles. A systolic array in accordance with disclosed implementations can be well suited for efficient parallel processing and can be particularly suited to tasks involving matrix operations and repetitive computations. Systolic arrays of disclosed implementations can be configured as a grid of interconnected processing elements (tiles) that work in parallel. The parallel nature of the systolic array of disclosed implementations enables it to handle multiple data points simultaneously, achieving high throughput, especially for tasks that require intensive matrix multiplication. The systolic array can be pipelined, further increasing parallelism achievable by the accelerator. The systolic array comprises a plurality of rows and a plurality of columns. The systolic array can include any number of tiles. Each tile can perform an operation, store results, combine results with output from a previous tile, and/or pass results to a next tile. The accelerator includes a row tail associated with each row within the plurality of rows. The row tail can perform functions such as storing, accumulating, etc. on results of the row.

The systolic array of tiles can comprise one or more multiply-add units. Multiply-add operations can be useful for accelerating AI computations due to their efficiency in handling repetitive mathematical tasks commonly found in machine learning algorithms. The operations can combine multiplication and addition in a single step, allowing processors to compute results faster and with lower latency. This capability can be particularly valuable in deep learning, where neural networks can perform vast numbers of matrix multiplications and summations to update weights and process data across multiple layers. Disclosed implementations can utilize parallel multiply-add units to perform multiple calculations simultaneously. This parallelism can be beneficial for accelerating deep learning training and inference, making it feasible to work with large datasets and complex models in real-time applications, such as natural language processing, image recognition, and autonomous systems.

The flow 100 includes receiving a request 112. The request can be a work request. The work request can specify a first matrix and a second matrix to be multiplied. Embodiments include receiving, by the accelerator, a work request from a processor core, wherein the work request includes the first matrix and the second matrix. The work request can include a memory location for the first and second matrix, a memory location to store results once the matrix multiplication is complete, and so on. The work request can include signals that control functions for elements of the accelerator such as the row tails, one or more answer buffers, and so on. In embodiments, the work request is based on an execution of a machine learning model. The machine learning model can include Deep Neural Networks (DNNs) that can include multiple layers. The machine learning model can include Convolutional Neural Networks (CNNs) that perform convolutions, and can utilize large kernel operations, feature maps, and so on. The machine learning model can include Recurrent Neural Networks (RNNs) and Long Short-Term Memory (LSTM) Networks, Transformers, Support Vector Machines (SVMs), and/or other suitable machine learning models.

The flow 100 includes saving the work request in a buffer 114. The work request can be issued by a processor and can be sent to the accelerator. The buffer can be a circular buffer. In embodiments, the work request is saved in a circular buffer within the accelerator. The circular buffer can include multiple entries to accommodate multiple work requests. The circular buffer may utilize one or more wrap bits to manage various circular buffer conditions, such as an empty condition and a full condition. In disclosed implementations, one or more wrap bits may be used to delineate between an empty condition of the circular buffer and a full condition of the circular buffer.

The flow 100 includes fetching matrices 116. The first matrix and the second matrix can be fetched from memory according to the location specified in the work request. In various machine learning configurations, layers of a neural network can include a weight matrix that couples layers within the network. The weight matrix can store the parameters (weights) learned during training. These weights can adjust the strength of the signal passed from one neuron to the next, allowing the network to perform a more accurate inference. The matrices can include a bias matrix. A bias matrix can include biases for each node of a neural network. The biases can allow each neuron to have a constant term added, providing flexibility and allowing more accurate training and inferencing. The various matrices can be fetched by the accelerator. Embodiments include fetching, from a memory hierarchy, the first matrix and the second matrix.

The flow 100 includes disabling one or more tiles 118. The memory hierarchy can include one or more caches such as an L1, L2, etc. cache. A miss can occur at any level in the memory hierarchy when the accelerator requests data. A cache miss can occur the first time data is accessed and is not yet in any cache level, when the cache is at capacity, and so on. A cache miss can cause the data to be retrieved from a higher level in the memory hierarchy, such as main memory, or even disk storage. Thus, in the case of a cache miss, many cycles can occur before the matrices are delivered to the accelerator. Embodiments can include disabling one or more tiles within the systolic array, wherein the disabling is based on a stall of the memory hierarchy. Disabling one or more tiles can save power during a cache miss or while the accelerator otherwise waits for matrix data. The entire array of tiles can be stalled.

The flow 100 includes converting floating-point data to a quintuple format 120. In embodiments, the first matrix and the second matrix comprise floating-point data. In embodiments, the floating-point data is based on a first data format. In some embodiments, the first data format comprises a brain floating-point 16(BF16 ) format. The first data format can include FP-16, MXFP8, MXFP6, MXFP4, INT8, or another data format. Once fetched, the first data format can be converted into an internal quintuple format used by the accelerator. Thus, embodiments include converting the floating-point data from the first data format to a quintuple format. In exemplary implementations, the quintuple format can include a valid bit, a sign bit, nine signed exponent bits, eight significant bits, and two status bits. The result of the multiplication, including the partial results, can be in the quintuple format. Thus, the answer matrix can be stored in the quintuple format. The answer matrix and other data can be converted back to the first data format prior to sending the data to the memory hierarchy. Embodiments include reconverting, by an output block, a final answer to the first data format. The data does not need to be converted. For example, the systolic array can handle other data types, such as BF16, directly. In embodiments, each row within the plurality of rows comprises a stream of eight BF16 format partial products. Thus, the answer matrix can be calculated in the same data format as the first data format. Regardless of the data format used in the array, the answer matrix in the first data format can be written to a memory location that was specified in the work request.

The flow 100 includes multiplying matrices 122. The systolic array multiplies a first matrix by a second matrix. In embodiments, the first matrix comprises a weight matrix. In other embodiments, the second matrix comprises an activation matrix. An activation matrix can be presented to an input layer of a neural network. The systolic array can then multiply the activation matrix and the weight matrix. The result of the multiplication of the first matrix and the second matrix can be stored in another matrix, which can be referred to as an answer matrix. The multiplying is based on a plurality of partial products. Once the weight array has been loaded into the systolic array, additional activation matrices can be rapidly multiplied with the weight array. In embodiments, the multiplying includes a product of a third matrix and the first matrix. In other embodiments, the third matrix comprises a second activation matrix.

The systolic array can be pipelined. Thus, in embodiments, the multiplying is pipelined. Each cycle of the systolic array can include an additional multiplication of an additional first and second matrix. For example, on a first cycle, tile A within row A of the systolic array can determine one or more partial products according to a first multiplication. Intermediate results can be forwarded by tile A to tile AA, which can be the next tile in row A. Tile AA can save the intermediate results that were forwarded. During a second cycle, tile A can work on one or more partial products corresponding to a second multiplication, while tile AA works on one or more second partial products associated with the first multiplication, adding the results with those that were forwarded by tile A. When the array comprises a 4×4 array of tiles, the array can be pipelined to operate on four multiplications at once.

The flow 100 includes producing partial products 130. A partial product can enable a complex multiplication, such as a matrix multiplication, to be broken into smaller operations. The partial products can include intermediate results of a matrix operation. When performing matrix multiplication, each element in a resulting matrix can be the sum of products from the corresponding rows and columns of the input matrices. In the context of a multiply-accumulate operation, for each element in the output matrix, pairs of corresponding elements from a row of the first matrix and a corresponding column of the second matrix can be multiplied. This function can be a dot product. Each of these products can be a partial product. As an example, to compute the value for an entry Ci, j in the output matrix C from matrices A and B, it is computed as: Ci,j=Ai,1·B1,j+Ai,2·B2,j+ . . . +Ai,n·Bn, j, where each term Ai, k×Bk, j can be a partial product. The partial products can then be summed together to form a final value in the output matrix.

A row within the plurality of rows of the systolic array produces one or more partial products within the plurality of partial products. Each tile within each row of the systolic array can produce one or more partial products. In embodiments, each tile within the systolic array includes eight multiply-accumulate units (MACs). Thus, in embodiments, the one or more partial products comprise eight partial products. A systolic array can include four rows of tiles, each tile producing eight partial products. Thus, in embodiments, the plurality of partial products comprises 32 partial products. In practice, the systolic array can comprise any number of tiles and rows, thus it can include more or less than 32 partial products. The eight partial products can be added respectively, as results are generated across each row of tiles within the systolic array. Thus, four streams of partial products can be included, each stream for the four rows of the systolic array. More or fewer streams can be included when more or fewer rows are included in the array. A final result in a tile of each row of the array can be accumulated with results from one or more prior matrix-multiply functions. This accumulation can be accomplished by a row tail and an answer buffer associated with each row (described below).

The flow 100 includes forwarding partial products 140. The partial products can be sent to other tiles within the same row. The partial products can then be added (described below) as each tile computes one or more partial products and sends those results to a next tile in the row. Eventually, the partial products are sent to a last tile within the row of the systolic array. Embodiments include forwarding, by a last tile within the row, to an associated row tail, the one or more partial products. A row tail can be associated with each row in the systolic array. The row tail can capture the set of added partial products that were sent down the row. When each tile can produce eight partial products, eight added partial products can be sent to each row tail.

The flow includes accumulating partial products 150. The associated row tail accumulates the one or more partial products that were forwarded with one or more previous partial products associated with the row. Recall that the tiles within a row of the systolic array can accumulate the results of one or more partial products, each tile forwarding results to a next tile in the row which accumulates a previous result of the partial product with a current result. A last tile in the row can forward the final set of accumulated partial products to a row tail associated with the row 152. The row tail can store the final set of accumulated partial products in an answer buffer. An answer buffer can be a temporary storage buffer. The row tail can perform other operations on the one or more accumulated partial products that were forwarded. For example, the row tail can add one or more previously calculated partial products from a previous multiply function to the one or more partial products that were forwarded. Accumulating results of multiple matrix-multiply operations can increase performance of AI functions. To accomplish this function, the row tail can prefetch a previous answer from the answer buffer to add to a current partial product. Embodiments include prefetching, by the associated row tail, from the answer buffer, the one or more previous partial products associated with the row. Recall that the systolic array can be pipelined. Thus, a new result (e.g., a new set of one or more partial products) can proceed from the systolic array every cycle. To keep up with the results, prefetching can also occur every cycle to ensure that a previous result is available to accumulate with the next result. As described previously, the systolic array can comprise any number of tiles. Thus, in embodiments, the multiplying, the forwarding, and the accumulating include one or more additional rows.

The flow 100 includes matching with an answer buffer 160. Embodiments include matching the associated row tail with an answer buffer. As described above, the answer buffer can serve as a temporary storage buffer used for performing matrix operations, such as matrix multiplications, multiply-accumulate operations, and so on. Each row tail can be associated with a unique answer buffer. For example, when the systolic array comprises a 4×4 array, there can be four rows with four answer buffers. Each answer buffer can be dedicated to a unique row and can perform functions outlined above. Since the systolic array can be pipelined, each answer buffer can handle a read (to prefetch previous results) and a write (to store current results) every cycle. The answer buffer can be implemented in static random-access memory (SRAM) banks. The SRAM banks can include High-Density (HD) SRAM. In disclosed implementations, the SRAM may utilize single-fin transistors. In embodiments, the answer buffer that was matched with the associated row tail comprises two or more static random-access memory (SRAM) banks, wherein each SRAM bank within the two or more SRAM banks includes a single port, wherein the answer buffer is capable of reading and writing on a single clock cycle. One or more implementations may use Quad Data Rate (QDR) SRAM. QDR SRAM can support data transfer on both edges of the clock cycle and includes separate ports for read and write operations, allowing simultaneous read and write actions. Exemplary implementations may use interleaved single ported banks controlled by each row tail. One or more implementations may utilize Synchronous SRAM (Sync SRAM). In synchronous SRAM, operations are timed with a clock signal, enabling improved synchronization with the accelerator. Other types of SRAM may be used in some implementations.

The flow 100 includes storing the result 170. As described above, a last tile in the row can forward the final set of respectively added partial products to a row tail associated with the row. The row tail can store the final set of partial products in an answer buffer. As described above, the row tails can accumulate results from one or more previous matrix-multiply functions. Thus, embodiments include storing, by the associated row tail, a result of the accumulating, wherein the storing is accomplished by the answer buffer. In embodiments, the storing is based on one or more control bits. The control bits can be associated with the work request.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

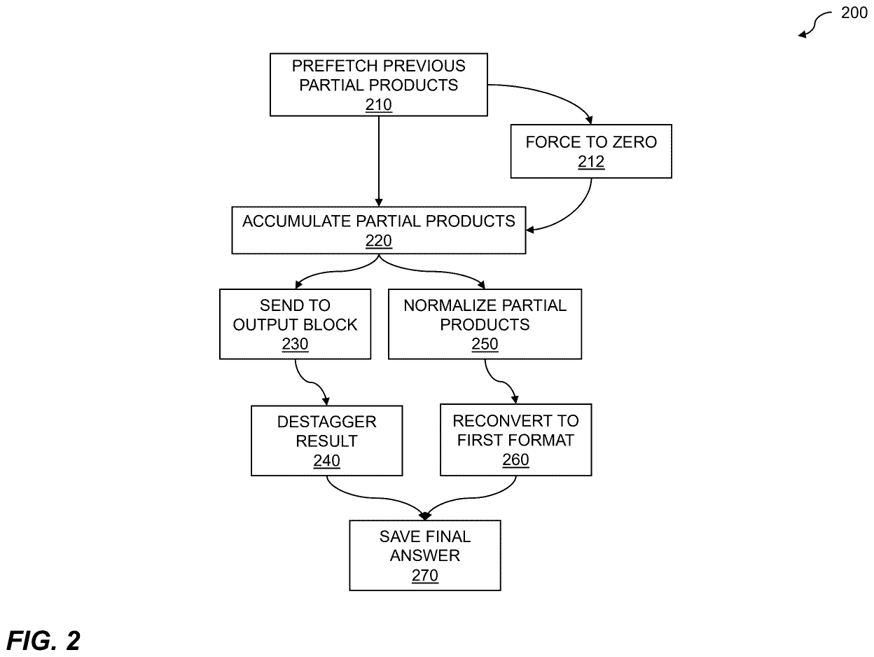

FIG. 2 is a flow diagram for saving a final answer. The flow 200 includes prefetching previous partial products 210. The previous partial products can include results from previous matrix multiplications, multiply-accumulate operations, and/or other suitable operations. The prefetching can be initiated by each row tail in the systolic array. The data that is prefetched can be sourced from an answer buffer that is associated with each row tail. As described above, the answer buffer can handle a read and write request every cycle to supply and store data from the row tail as it executes a multiply of partial products from one or more matrix-multiply operations. The net effect can be to accumulate results from one or more matrix-multiply functions. However, when the first multiply function is operating in the array, there are no previous results stored in the answer buffer with which to accumulate. In this case, the row tails can force to zero 212 the value prefetched from the answer buffer. Thus, embodiments include forcing the one or more previous partial products to zero, wherein the forcing is based on one or more control bits. The one or more control bits can indicate that the current matrix-multiply function is a first matrix-multiply in the array. In exemplary implementations, the control bits can be prepended or appended to partial product data. The control bits can include a first bit and a last bit. The first bit being asserted can cause a row tail to put an answer in the corresponding answer buffer. The last bit being asserted can cause a result to be sent to an output block. When neither the first bit nor the last bit are set, that condition can cause the row buffer to add the result row to the value in the answer buffer and store the result back in the answer buffer. In embodiments, the storing is based on one or more control bits. In exemplary implementations, when the first bit is set, the partial products in the answer buffer are set to zero, thereby initializing the answer buffer. Embodiments can include forcing the one or more previous partial products to zero, wherein the forcing is based on one or more control bits.

The flow 200 includes accumulating partial products 220. The accumulating can include partial products from one or more previous matrix-multiply operations performed by the array. As described above and throughout, tiles within a row of the systolic array can sum the results of one or more partial products, each tile sending results to a next tile in the row. Thus, as one tile completes the computation of one or more partial products, results can be sent to the next tile in the row. The next tile can also perform one or more partial product calculations and can then respectively add each partial product with results from the previous tile. This operation can occur across the entire row until the row tail receives the full result of the one or more partial products. Each row within the systolic array can perform the above multiply-add function. When each tile in the row completes its multiply-add operation, results can be forwarded to an associated row tail. The results can be saved to an answer buffer associated with the row tail. As described above, data can be prefetched from the answer buffer and can be used to accumulate results in the row rails. The flow 200 can include sending partial products to an output block 230. In exemplary implementations, when a control bit such as a last bit is set, results in the row tail and/or answer buffer are sent to the output block as part of the process of providing matrix multiplication results to the processor. Thus, embodiments can include sending, to an output block, by the associated row tail, a result of the accumulating. In embodiments, the sending is based on one or more control bits.

Execution within the systolic array can be staggered. That is, once a weight array is loaded into the systolic array, activations from an activation array can be sent to each tile with a row in subsequent accelerator cycles. The sending can be based on one or more column headers. The column headers can be associated with a column of the systolic array. For example, in clock cycle 1, a first column header can send an activation to a first tile in the first row within the systolic array. The first tile in the first row can then begin calculating one or more partial products. In cycle 2, a second column header can send an activation to a second tile in the first row within the systolic array. The second tile can calculate one or more partial products and add those partial products, respectively, with the partial products from the first tile that are forwarded to the second row on the second cycle. Also, during the second cycle, the first column header can send an activation to the first tile in the second row of the systolic array. The first tile in the second row can perform calculations for one or more partial products that will be sent to the second tile in the second row on the next cycle. Thus, the partial products can flow across the systolic array in a “wave” or staggered pattern. The end result is that the partial products are received by the row tails associated with each row in subsequent accelerator cycles. That is, a first row tail associated with a first row can then send results to the output block on a first cycle. A second row tail associated with a second row can send results to the output block on the next cycle, and so on. In embodiments, the sending includes a second associated row tail associated with a second row within the plurality of rows, wherein the sending includes a second result of the accumulating. In embodiments, the sending is staggered between the associated row tail and the second associated row tail, wherein the staggering is based on a clock cycle of the accelerator.

The flow 200 includes destaggering a result 240. Since results from each of the row tails can be sent to the output block in a staggered fashion, the output block must destagger the results before sending the result back to the processor. The destaggering can include arranging temporally staggered partial products in an output block as an array, such that the array can be transmitted to, and stored in, an L2 cache, for consumption by a processor. Embodiments include destaggering, by the output block, the result of the accumulating and the second result of the accumulating, wherein the destaggering results in a final answer.

The flow 200 includes saving a final answer 270. The saving of the final answer can include saving the final answer in an L2 cache, for consumption by a processor. The address of the final answer can be determined by the work request. Embodiments can include saving, in a hierarchical cache, the final answer. The accelerator can signal to the processor that results have been stored. The signaling can include an interrupt, semaphore, control signal, and so on. The flow 200 can include normalizing partial products 250. Recall that a first floating point format can be converted to a quintuple format which can be used in the tiles within the systolic array to perform matrix-multiply functions. The quintuple format can include nine signed exponent bits and eight significand bits. Each tile can compute one or more partial products by performing one or more multiply functions on the floating-point data. The partial products can be normalized as part of the accumulating process. In embodiments, the accumulating includes normalizing the one or more partial products that were forwarded. The partial products can be normalized as part of the multiplying process. That is, each tile in the array can perform a normalization after it calculates partial products and adds them, respectively, to partial products calculated from a previous tile.

The flow 200 includes reconverting to a first format 260. The reconverting can include reconverting from quintuple format to another floating-point format, such as FP-16, BF16, MXFP8, MXFP6, MXFP4, and INT8. The BF16, or bfloat16 (short for “brain floating point”), is a 16-bit floating-point format widely used in deep learning and AI applications. It has 1 sign bit, 8 exponent bits, and 7 mantissa (significand) bits. Unlike the IEEE half-precision float (FP16), which has a 5-bit exponent, BF16 has the same exponent width as a single-precision float (FP32), making it capable of representing a much larger dynamic range. BF16 provides a balanced approach for deep learning applications by leveraging the speed and memory efficiency of a 16-bit format without sacrificing the range required for complex computations. Moreover, the reduced bit width enables faster data throughput, which accelerates matrix multiplications and other core operations in AI, making BF16 ideal for applications such as image recognition, natural language processing, recommendation systems, and/or other machine learning applications.

The MXFP4, MXFP6, and MXFP8 floating-point formats are part of the Microscaling Formats (MX) specification developed by the MX Alliance and are optimized for AI applications where energy efficiency and memory bandwidth reduction are priorities. MXFP6 is especially well-suited for deep learning models that involve large datasets, such as image classification, language processing, and speech recognition. By using lower-bit formats, including MXFP6, these applications can perform faster inference with smaller memory footprints, making them suitable for hardware with limited memory and energy constraints, such as edge devices. In exemplary implementations, other floating-point formats may be used instead of, or in conjunction with, one or more of the aforementioned formats.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

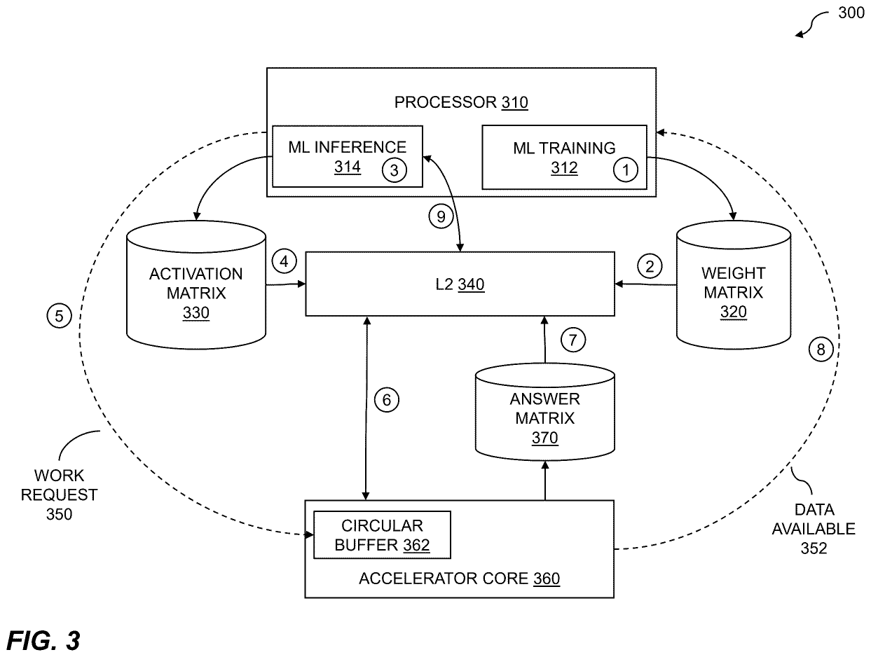

FIG. 3 is an infographic for a systolic array matrix-multiply accelerator with row tail accumulation. The infographic 300 includes a processor 310. The processor 310 can include a RISC-V processor, MIPS processor, ARM processor, x86 processor, or other suitable processor type. The processor 310 can include a module for machine learning training 312. The module for machine learning training can include functions and instructions for training a machine learning model. The training can include deriving a weight matrix 320. One or more exemplary implementations may utilize Random Initialization with Gradient Descent. At the start of training, weights in the matrix can be initialized randomly, with values selected from a small range to prevent the network from being biased in one direction. The training process then can use a gradient descent algorithm (or one of its variants) to adjust these weights based on the model error, iteratively minimizing the loss function. In exemplary implementations, the adjustment is accomplished through backpropagation, where gradients of the error with respect to each weight are calculated, and the weights are updated accordingly in the weight matrix. The weight matrix is then loaded into an L2 cache 340. Once the training is complete, the model can be used for inferencing. The processor 310 can include a module for machine learning inference 314. The module for machine learning inference can include functions and instructions for inferencing using a previously trained machine learning model. The inferencing can include deriving an activation matrix 330. In exemplary implementations, during the inferencing process, the activation matrix can be computed by feeding input data through a neural network, layer by layer, using the learned weights and biases. Each layer applies its specific activation function, such as ReLU (rectified linear unit), Sigmoid, or the like, on the linear combination of inputs and weights. The resulting values form the activation matrix for each layer, which can then become the input for the next layer. The activation matrix 330 is also loaded into the L2 cache 340.

With the weight matrix 320 and activation matrix 330 loaded into the L2 cache 340, the accelerator core 360 can receive a work request 350 from the processor 310. In exemplary implementations, the processor 310 issues work requests once the weight matrix 320 and activation matrix 330 are successfully loaded into the L2 cache 340. The work request can include an instruction to perform a matrix operation, such as a matrix multiplication, multiply-accumulate operation, normalization, and/or other operations. The work request can be based on a semaphore. In exemplary implementations, a circular buffer 362 within the accelerator core 360 receives the work request. In exemplary implementations, the circular buffer includes multiple entries and therefore has the capability to store multiple work requests. Thus, in exemplary implementations, the work requests can be queued.

The accelerator core 360 retrieves work requests from the circular buffer. The work request can specify a source address within the L2 cache that corresponds to the weight matrix. Additionally, the work request can specify a source address within the L2 cache that corresponds to the activation matrix. The work request can include an instruction to perform multiplication, multiply-accumulate, normalization, and/or other matrix operations. The results are put into answer matrix 370. The work request can specify a destination address within the L2 cache at which the accelerator can store the answer matrix. Once the answer matrix is stored in the L2 cache, the accelerator core can assert a data available signal 352, to indicate to the processor that the answer matrix is available for retrieving from the L2 cache. The data available signal can be based on a semaphore. A cache miss can occur, which can cause the accelerator core to pause until the activation matrix and weight matrix are loaded.

In exemplary implementations the work request can include an opcode field. The opcode field can be used by the accelerator core to determine the operation type. Operation types can include matrix operations, such as multiplication, addition, subtraction, division, and other operations that can occur on matrices. The opcode field can include a flush operation. The flush operation, when received by the accelerator core, can cause the accelerator core to discard all pending work requests in the circular buffer 362. The flush operation can enable improved resource management. When a queue has accumulated several pending requests that are no longer needed, perhaps due to updated data or an interrupted operation, the flush operation of disclosed implementations allows the accelerator core to discard these requests, freeing up space and resources. In exemplary implementations, the work request can include stride parameters. The stride parameters can be used to program one or more registers to use an indexed stride that is compatible with the size of a given weight matrix, activation matrix, and/or answer matrix. Setting a compatible stride can increase efficiency when fetching matrix data from the L2 cache 340.

As the machine learning model continues to execute, another activation matrix can be sent to the L2 cache and the process can restart. When restarting, the weight matrix can be saved within the accelerator core so that only the new activation matrix needs to be loaded to perform another matrix multiplication. In this way, the weights can be “stationary” in the accelerator. The weight stationary approach provides an advantage of allocating more bandwidth to activation matrix data once the weight matrix has been loaded.

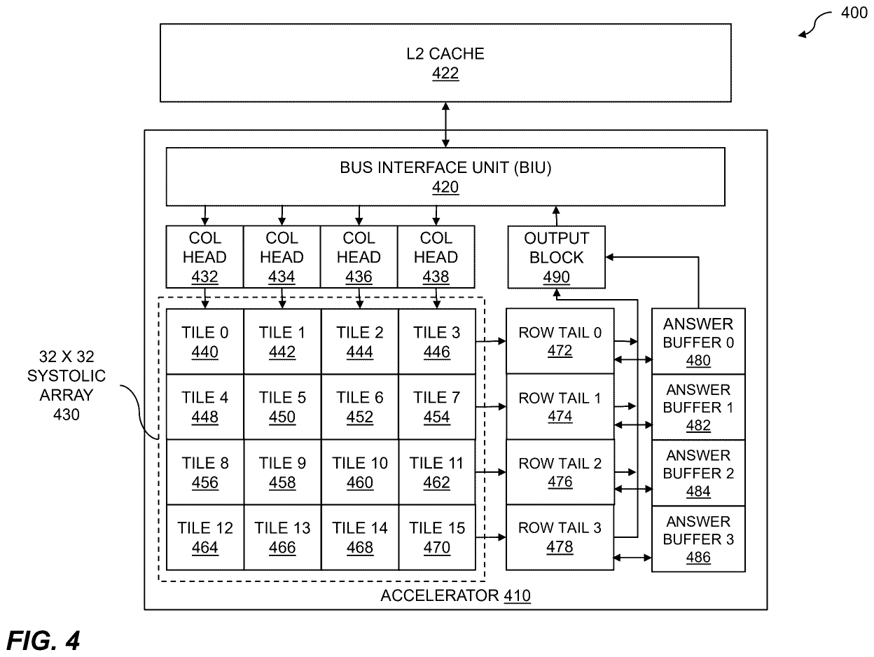

FIG. 4 is a block diagram of a systolic array matrix-multiply accelerator with row tail accumulation. The block diagram 400 shows a 32×32 systolic array 430 which can be coupled to a memory hierarchy. The memory hierarchy can include an L2 cache 422. The L2 cache 422 can be tightly coupled to a processor core to enable fast data sharing between the accelerator 410 and a processor core. The L2 cache can be coherent. The memory hierarchy can include any number of caches, main memory, disk storage, and so on. The accelerator can include a bus interface unit (BIU) 420. The BIU can provide control for communications between the accelerator and the L2 cache. These communications can include loading a weight matrix, loading an activation matrix, storing an answer matrix, and so on. The accelerator can include one or more column headers. The column headers are shown at 432, 434, 436, and 438 on block diagram 400. The column headers can load data from one or more matrices from the BIU into an array within the accelerator. The column headers can unpack data from the BIU into an internal input format. In exemplary implementations, the internal input format can include a quintuple format. The column heads can shift data into the array in a staggered manner. The shifting can be based on one or more registers to ensure that timing requirements are met due to long RC delays down columns of the array. The array can comprise a grid of 16 tiles as shown in block diagram 400. Each tile can include eight multiply-add units. Thus, the entire array can comprise a 32×32 systolic array 430. Each multiply-add unit can comprise a vector dot product engine that can perform a dot product operation on BF16 data types, MXFP8, MXFP6, MXFP4, INT8, and/or other suitable data types. In exemplary implementations, each of the eight vector dot product engines within each of the 16 tiles can be called a VDP 16. Results from each multiply-add (or VDP16) can be summed and added across the array. The final partial product results can be saved in a row tail. Thus, as shown in block diagram 400, a first row in the multiply-add array can create partial products corresponding to a first portion of the 32 dot products via tiles 440, 442, 444, and 446. The results of the first row of tiles can be summed and saved in the row tail 472. A second row in the multiply-add array can create partial products corresponding to a second portion of the 32 dot products via tiles 448, 450, 452, and 454. The results of the second row of tiles can be summed and saved in the row tail 474. A third row in the multiply-add array can create partial products corresponding to a third portion of the 32 dot products via tiles 456, 458, 460, and 462. The results of the third row of tiles can be summed and saved in the row tail 476. A fourth row in the multiply-add array can create partial products corresponding to a fourth portion of the 32 dot products via tiles 464, 466, 468, and 470. The results of the fourth row of tiles can be summed and saved in the row tail 478. Using the structure shown in block diagram 400, the accelerator can load a 32×32 weight matrix into the array, load a 32×32 activation matrix into the array, and perform the matrix multiplication by using the multiply-add operations arranged in disclosed rows and columns.

The systolic array can be pipelined. Each cycle of the systolic array can start an additional multiplication of an additional activation matrix by the loaded weight matrix. For example, on a first cycle, column header 432 can send an activation to tile 0 which can determine a first partial product according to a first multiplication. Results can be forwarded by tile 0 to tile 1, where it can be saved for use in the next cycle. During a second cycle, multiple actions can occur. Column header 432 can send another activation to tile 0 which can determine a first partial product according to a second multiplication. Also in the second cycle, tile 1 can execute the second partial product of the first multiplication, accumulating results with those that were forwarded by tile 0 in the previous cycle. Finally, in the same cycle, column header 432 can send another activation corresponding to the first multiplication to tile 4. Since each row can work on four partial products, the column header can send tile 4 an activation associated with a fifth partial product. In this way, multiple multiplications can proceed in a “diagonal wave” across the systolic array. When the array comprises a 4×4 array of tiles, the array can be pipelined to operate on four multiplications at once.

The row tails can send results to a corresponding answer buffer which can save one or more answer matrices from one or more matrix-multiply functions. The BIU can store one or more answer matrices back to the memory hierarchy. In the block diagram 400, row tail 0 472 is matched with corresponding answer buffer 0 480. Row tail 1 474 is matched with corresponding answer buffer 1 482. Row tail 2 476 is matched with corresponding answer buffer 2 484. Row tail 3 478 is matched with corresponding answer buffer 3 486. One or more implementations can include more or fewer rows and columns than depicted in FIG. 4.

The row tails and/or answer buffers can send data to the output block 490. The data may arrive at the output block in a staggered manner. Thus, in embodiments, the sending is staggered between the associated row tail and the second associated row tail, wherein the staggering is based on a clock cycle of the accelerator. The output block 490 can temporally destagger the output by collecting the entire answer matrix in the output block over a number of clock cycles. Thus, embodiments can include destaggering, by the output block, the result of the accumulating and the second result of the accumulating, wherein the destaggering results in a final answer. Once the output block contains a complete answer matrix, the output block provides the answer matrix data to the bus interface unit. The bus interface unit then loads the answer matrix data in the L2 cache.

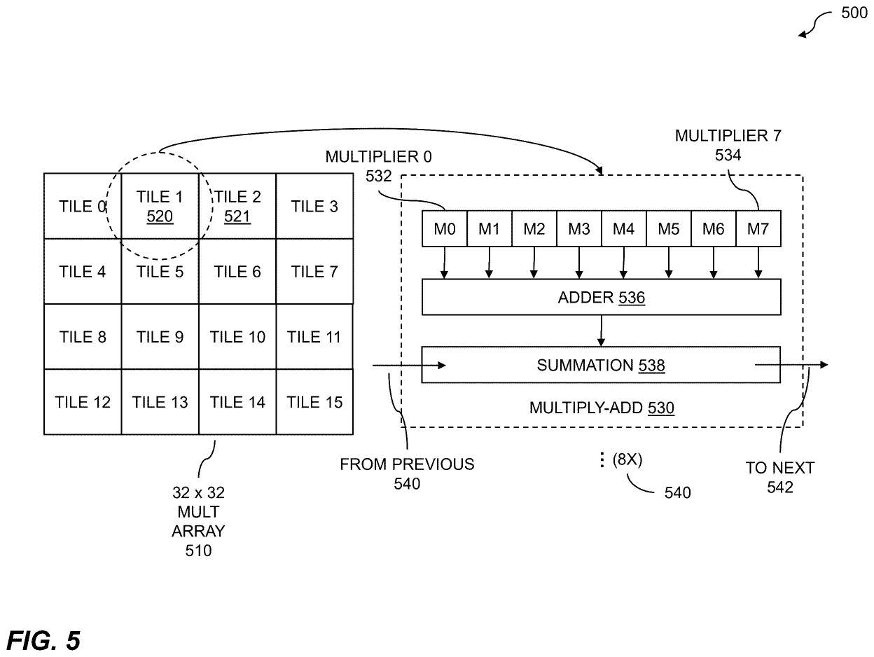

FIG. 5 is a block diagram of a systolic array. A weight-stationary matrix-multiply accelerator can include a systolic array of 16 tiles as shown in block diagram 500. In embodiments, each tile within the systolic array of tiles includes eight multiply-accumulate units (MACs). Thus, the entire array can comprise a 32×32 multiply array 510. The block diagram 500 shows the details of a tile such as tile 1 520. A single multiply-add unit 530 of eight total multiply-add units 540 within tile 1, is shown. In embodiments, each row within the plurality of rows comprises a stream of eight partial products which can be part of a matrix-multiply operation. Each multiply-add unit can include eight separate multiplier units. These can be multiplier 0 532 through multiplier 7 534, as shown in block diagram 500. Multiplier 0 can be aligned on the left of each multiply-add unit and multiplier 7 can be aligned on the right of each multiply-add unit. Other alignments are possible. Each of the multiplier units within the multiply-add unit can perform eight multiplications on various data formats such as BF16 data, FP16 data, MXFP8 data, MXFP6 data, MXFP4 data, INT8 data, and/or other suitable data types and/or other data formats. The data formats can include an internal quintuple format (previously described) that can be generated by the aforementioned column heads. Once the multiplications are complete within the tile, each set of eight multipliers can be summed by an adder, such as adder 536. The results of the adder can be sent to a summation block 538 within the multiply-add unit. The summation block can take one of eight previous partial product results from a previous multiply-add unit 540, add current results from the adder, and send to the next multiply-add unit 542 for continued summation of partial products across the entire row of multiply-add units across the array. The multiply-add unit 530 can include one or more arithmetic units to perform multiply and/or addition operations. In exemplary implementations, special processing is performed to accommodate scenarios such as handling infinity, and/or Not-a-Number (NaN) conditions. In exemplary implementations, a lookup table is used to determine if a special case result is zero, NaN, or a signed infinity value. The lookup table can include two input arguments that include two input values for an arithmetic operation. As an example, for multiplication, a NaN input value in conjunction with any other value results in a NaN output value. Similarly, for addition, a first input argument of infinity and a second input argument of negative infinity results in a NaN output value. Thus, disclosed implementations can utilize a lookup table to accommodate special conditions and corner cases associated with NaN, infinity, zero, and/or other unusual values.

Aforementioned row tails can store the summed result of all partial products in the row at the end of the array. Each tile can comprise a stack of eight multiply-add units, each summing results across a row of the array, such as described above. For example, the eight multiply-add units within tile 520 can multiply 64 different sets of values and can use adders to create eight results that are sent along rows as inputs to the summation block in the following tile 521. The same function can be performed by tile 521, passing eight partial product results to the next tile. This process can continue until the final result of the row is stored in the row tail.

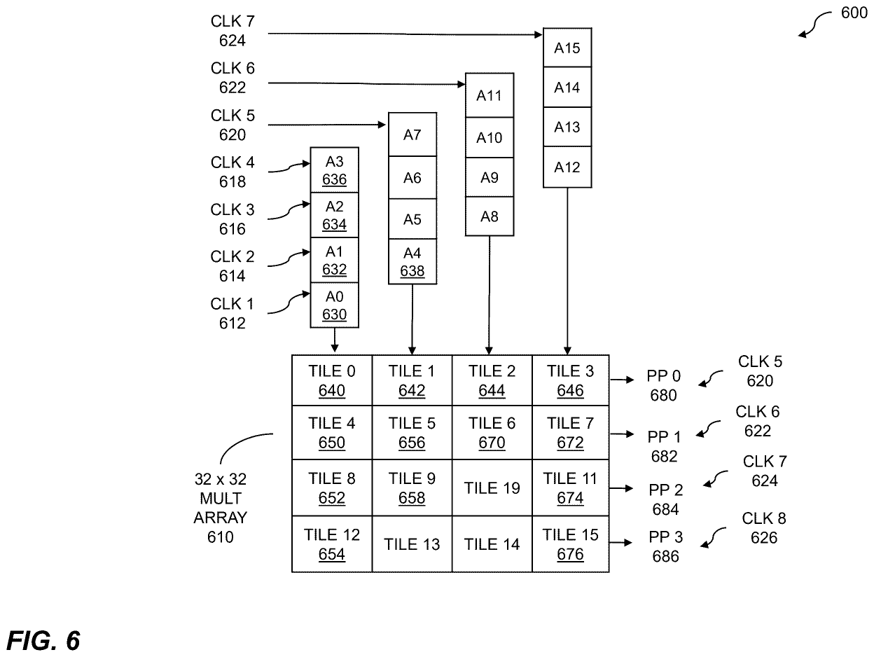

FIG. 6 is a block diagram of staggered execution. In the block diagram 600, seven clock cycles are indicated, shown as CLK 1 612, CLK 2 614, CLK 3 616, CLK 4 618, CLK 5 620, CLK 6 622, and CLK 7 624. With each clock cycle, data is fed from one or more column headers into the first row of tiles of a systolic array, indicated as tile 0 640, tile 1 642, tile 2 644, and tile 3 646. On the first clock cycle (CLK 1 612), activation matrix element A0 630 is loaded into tile 0. On the second clock cycle (CLK 2 614), the activation matrix element A1 632 is loaded into tile 4 650, while matrix element A4 638 is loaded into tile 1 642. In clock cycle 3 616, matrix element A2 634 is loaded into tile 8 652 while matrix element A5 is loaded into tile 5 656, and matrix element A8 is loaded into tile 2 644. In clock cycle 4 618, matrix element A3 636 is loaded into tile 12 654, while matrix element A6 is loaded into tile 9 658, matrix element A9 is loaded into tile 6 670, and matrix element A12 is loaded into tile 3 646. The process continues until all the activation matrix elements A0 through A15 propagate through the array 610. Upon completion of CLK 5 620, a first partial product (PP 0 680) is available at the output of tile 3 646. Similarly, upon completion of CLK 6 622, a second partial product (PP 1 682) is available at the output of tile 7 672, and upon completion of CLK 7 624, a third partial product (PP 2 684) is available at the output of tile 11 674. By clock cycle 8 (CLK 8 626), the final partial product (PP 3 686) is available at the output of tile 15 676. Accordingly, the output that includes the partial products is staggered as it exits the systolic array.

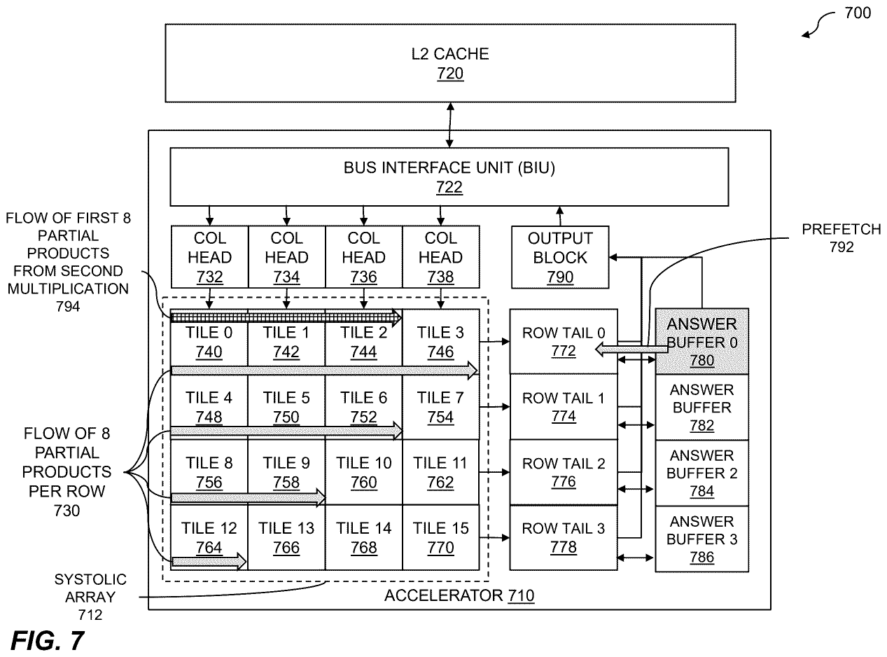

FIG. 7 is a first block diagram of row tail function. The block diagram 700 shows an AI accelerator 710 which can be coupled to a memory hierarchy. The accelerator can include a systolic array 712. The memory hierarchy can include an L2 cache 720. The L2 cache can be tightly coupled to a processor core to enable fast data sharing between the accelerator and a processor core. The L2 cache can be coherent. The memory hierarchy can include any number of caches, main memory, disk storage, and so on. The accelerator can include a bus interface unit (BIU) 722. The BIU can provide control for communications between the accelerator and the L2 cache. These communications can include loading a weight matrix, loading an activation matrix, storing an answer matrix, and so on. The accelerator can include one or more column headers. The column headers are shown at 732, 734, 736, and 738 on block diagram 700. The column headers can load data from one or more matrices from the BIU into the systolic array. Data from the L2 can be in a first data format. The first data format can be a floating-point format. The column headers can convert data from the BIU into an internal input format. The internal input format can include a quintuple format. Thus, embodiments can include converting the floating-point data from the first data format to a quintuple format. Each tile can comprise a multiply-add unit. Each multiply-add unit can operate on a partial product of a matrix-multiply function. The multiply-add units can comprise a vector dot product engine that can perform a dot product operation on a quintuple data type. The multiply-add units can operate on other data types such as BF16, MXFP8, INT8, and so on.

The systolic array can provide acceleration for multiplying matrices. As described earlier, a matrix multiplication can be based on a plurality of partial products. Thus, a 32×32 matrix multiplication can be divided into the sum of 32 partial products. In embodiments, the plurality of partial products comprises 32 partial products. The 32 partial products can be calculated and added by the systolic array. The systolic array can comprise a grid of 16 tiles as shown in block diagram 700. Each tile can include eight multiply-add units. Since there are four tiles in a row, each row can produce a total of 32 partial products. Since there are four rows and four columns, the entire systolic array can perform a 32×32 multiplication. The 32 partial products calculated in each row are best envisioned as a stream of eight partial products being calculated and added across each row, one tile (cycle) at a time.

A weight matrix can be loaded into the systolic array by the column headers. Each column header can load a value corresponding to the weight matrix, or another matrix, into each tile in the respective column. For example, column header 732 can load values of the weight matrix, corresponding to the aforementioned partial products, into tiles 740, 748, 756, and 764. The loading can occur in a single cycle. The other column headers can load the tiles in their corresponding columns in the same cycle. Thus, the weight matrix can be loaded into the systolic array in a single accelerator cycle. When the array is large, additional cycles may be required to accommodate longer RC paths. In this case, the loading can take longer than a cycle as one or more registers can be included to ensure that timing requirements are met.

The column headers can shift partial product data corresponding to an activation matrix, or another matrix, into the array. The shifting can occur “just in time” as each tile needs to receive new data down each row. For example, once a weight array has been loaded into the systolic array, column header 732 can send data for eight partial product calculations to tile 0 740. Tile 0 can calculate the eight partial products, and forward results to tile 1 742. On the next cycle, column header 734 can send data for the next eight partial product calculations to tile 1 742. Tile 1 can compute the next eight partial products and add each partial product with the corresponding partial product sent from tile 0 the cycle prior. Operations can continue in like manner down each row. The array can include up to four staggered streams of eight partial products corresponding to a single multiply function as shown at 730. As the four streams flow across the row, they are received at a row tail associated with each row. The first row of the array can produce eight partial products via tiles 740, 742, 744, and 746. The results of the first row of tiles can be saved in the row tail 0 772. The second row of the array can produce another eight partial products via tiles 748, 750, 752, and 754. The results of the second row of tiles can be saved in the row tail 1 774. The third row of the array can produce another eight partial products via tiles 756, 758, 760, and 762. The results of the third row of tiles can be saved in the row tail 2 776. The fourth row of the array can produce a final eight partial products via tiles 764, 766, 768, and 770. The results of the fourth row of tiles can be saved in the row tail 3 778. The array can comprise more or fewer rows and columns. Because each row's calculations for a given matrix multiply operation can be separated by a cycle, the systolic array can produce staggered results. That is, as the group of eight partial products are calculated and summed across each row, row tail 0 can receive an answer on a first cycle, row tail 1 can receive an answer on the second cycle, row tail 3 can receive an answer on a third cycle, and row tail 4 can receive an answer on a fourth cycle.

Embodiments include matching the associated row tail with an answer buffer. Thus, results within the row tails can be saved in a matched answer buffer. In block diagram 700, row tail 0 is matched with answer buffer 0 780, row tail 1 is matched with answer buffer 1 782, row tail 2 is matched with answer buffer 2 784, row tail 3 is matched with answer buffer 3 786. The row tails may read, modify, and/or write values to their corresponding answer buffers. In exemplary implementations, one or more control bits control the functionality of the row tails. The control bits can include a first bit and a last bit. The answer buffers and/or row tails can send results to the output block 790. Thus, embodiments include sending, to an output block, by the associated row tail, a result of the accumulating. In embodiments, the sending is based on one or more control bits. The control bits can include a first bit. The first bit can indicate that a corresponding set of eight partial products is the first set associated with the multiply function. The control bits can include a last bit. The last bit can indicate that a corresponding set of eight partial products is the last set associated with the multiply function. Thus, the last bit can indicate that the multiply operation is complete and can be sent to the output block. The control bits can be included in data sent down the rows of the systolic array. Before sending the result (a final answer) back to the L2, the output buffer can destagger the results from each row of the array. Thus, the partial products that were generated in four different clock cycles within the array can be combined and sent to the L2 at once. In embodiments, the sending includes a second associated row tail associated with a second row within the plurality of rows, wherein the sending includes a second result of the accumulating. In some embodiments, the sending is staggered between the associated row tail and the second associated row tail, wherein the staggering is based on a clock cycle of the accelerator. Other embodiments include destaggering, by the output block, the result of the accumulating and the second result of the accumulating, wherein the destaggering results in a final answer. Embodiments include saving, in a hierarchical cache, the final answer.

The systolic array can be pipelined. Recall that the accelerator can multiply a first matrix and a second matrix. In embodiments, the multiplying is pipelined. Thus, as eight partial products associated with a first matrix multiplication flow down a row, another eight partial products associated with a second matrix-multiply function can follow one cycle behind. In embodiments, the multiplying includes a product of a third matrix and the first matrix. In embodiments, the third matrix comprises a second activation matrix. For example, as shown in 794, when tile 3 746 is calculating a fourth set of eight partial products for a first multiply calculation, tile 2 744 can be calculating a third set of eight partial products for a second multiply calculation. In this way, the systolic array can actively work on up to four matrix-multiply operations at once. The results of multiple multiplication operations can be accumulated. Each row tail that is associated with a row can prefetch 792 a previous eight partial products from an associated answer buffer. The previous eight partial products can be from a previous multiply function. In embodiments, the accumulating includes prefetching, by the associated row tail, from the answer buffer, the one or more previous partial products associated with the row. The prefetching can occur prior to the last tile in the row forwarding results to the row tail. Each row tail can prefetch the previous eight partial products from the output buffer in one cycle and can send the current eight partial products from the last tile in the row in a following cycle. Each row tail can then accumulate the partial products respectively. On a next cycle, the accumulated results can be stored back into the answer buffer while the results can be prefetched for the next multiply operation occurring in the array. The prefetch can be bypassed. As described previously, control bits can be included in the work request to the accelerator. In response to detecting a first bit being set, a row tail can set the data prefetched from the answer buffer to zero, as an initialization condition.

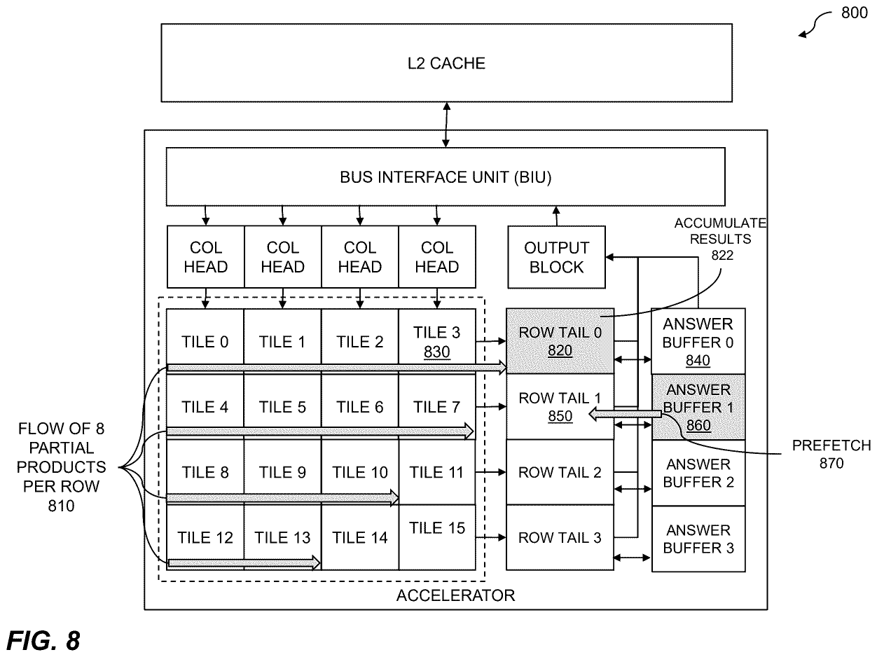

FIG. 8 is a second block diagram of row tail function. The block diagram 800 is based on the block diagram of row tail function shown in FIG. 7 and described previously. Accordingly, components in FIG. 8 are similar to counterpart components shown in FIG. 7. FIG. 8 shows the block diagram of FIG. 7, at a subsequent clock cycle, and with the flow of eight partial products per row, indicated at 810. As shown in block diagram 800, row tail 0 820 is updated with partial product information provided by tile 3 830, which is accumulated 822 with data that was previously prefetched from answer buffer 840. During the same cycle, row tail 1 850 prefetches data from corresponding answer buffer 1 860 via prefetch operation 870.

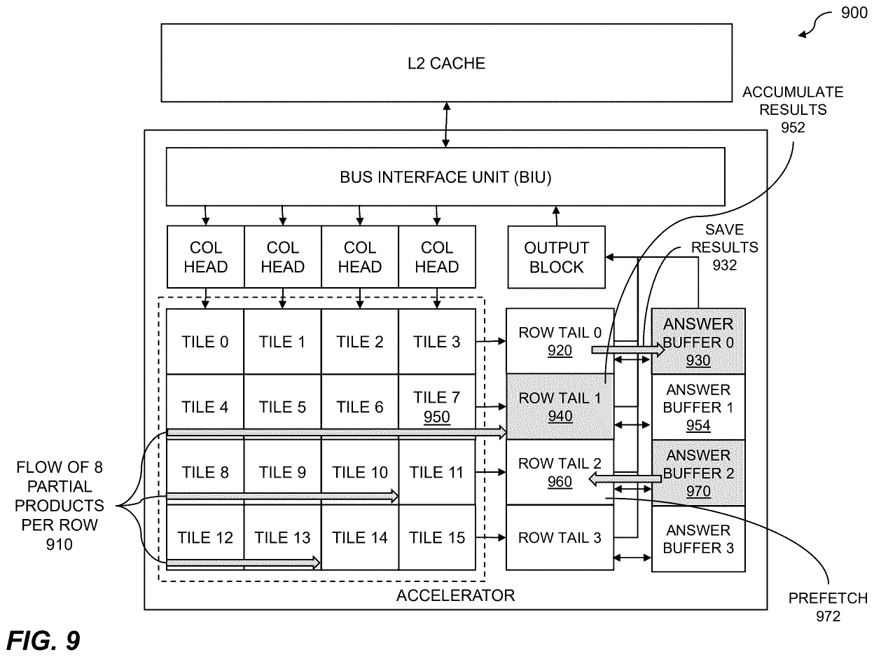

FIG. 9 is a third block diagram of row tail function. The block diagram 900 is based on the block diagram of row tail function shown in FIG. 7 and described previously. Accordingly, components in FIG. 9 are similar to counterpart components shown in FIG. 7. FIG. 9 shows the block diagram of FIG. 8, at a subsequent clock cycle, and with the flow of eight partial products per row, indicated at 910. As shown in block diagram 900, row tail 0 920 updates answer buffer 0 930 with partial product information via save operation 932. On the same cycle, row tail 1 940 receives partial product information from tile 7 950, which is accumulated 952 with data that was previously prefetched from answer buffer 954. During the same cycle, row tail 2 960 prefetches previous results from answer buffer 2 970 via prefetch operation 972.

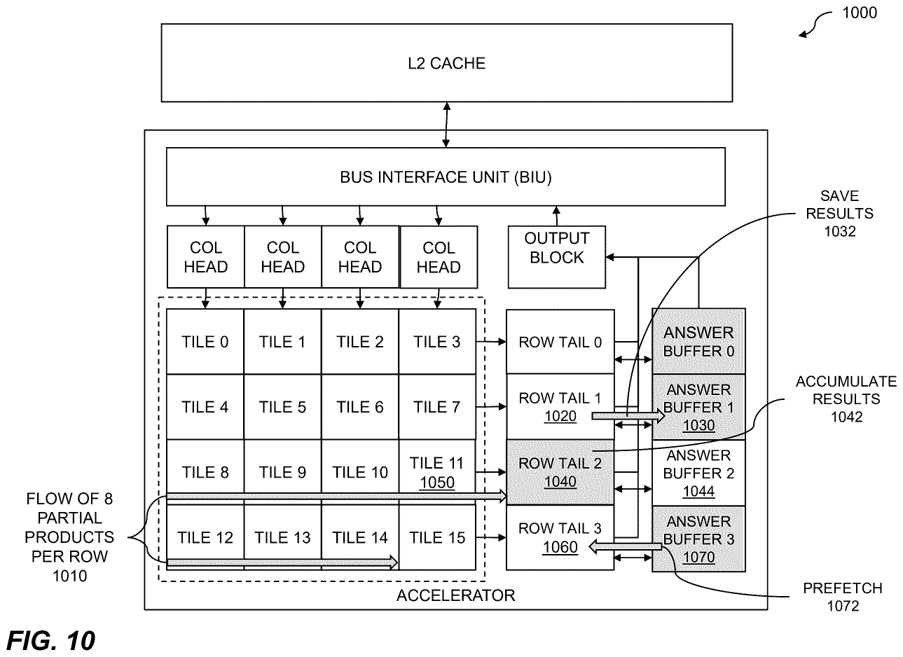

FIG. 10 is a fourth block diagram of row tail function. The block diagram 1000 is based on the block diagram of row tail function shown in FIG. 7 and described previously. Accordingly, components in FIG. 10 are similar to counterpart components shown in FIG. 7. FIG. 10 shows the block diagram of FIG. 9, at a subsequent clock cycle, and with the flow of eight partial products per row, indicated at 1010. As shown in block diagram 1000, row tail 1 1020 updates answer buffer 1030 with partial product information via save operation 1032. Similarly, row tail 2 1040 receives partial product information from tile 11 1050 which is accumulated 1042 with data that was previously prefetched from answer buffer 1044. During the same cycle, row tail 3 1060 prefetches intermediate results from answer buffer 3 1070 via prefetch operation 1072.

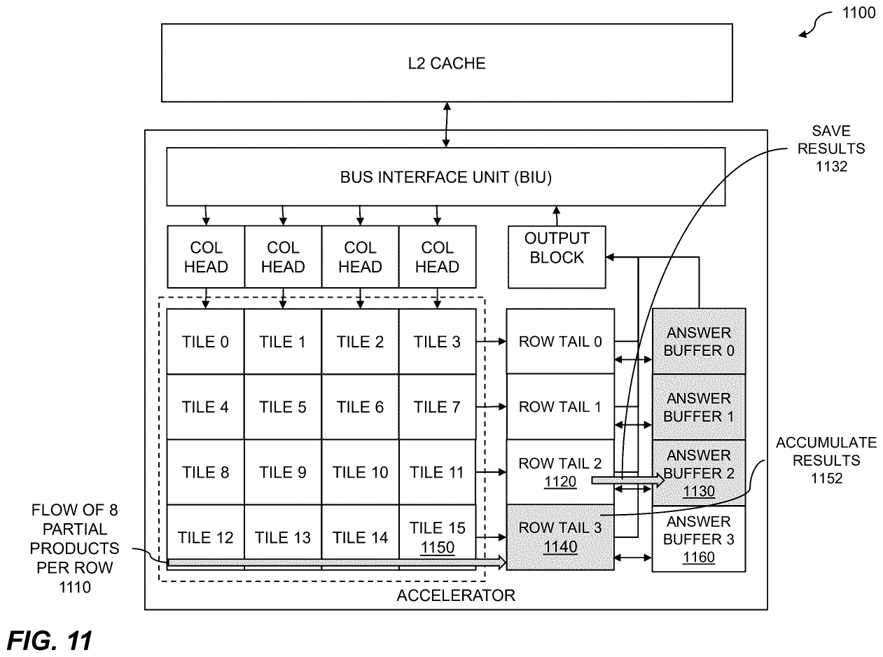

FIG. 11 is a fifth block diagram of row tail function. The block diagram 1100 is based on the block diagram of row tail function shown in FIG. 7 and described previously. Accordingly, components in FIG. 11 are similar to counterpart components shown in FIG. 7. FIG. 11 shows the block diagram of FIG. 10, at a subsequent clock cycle, and with flow of eight partial products per row, indicated at 1110. As shown in block diagram 1100, row tail 2 1120 updates answer buffer 2 1130 with partial product information via save operation 1132. Similarly, row tail 3 1140 receives partial product information from tile 15 1150, which is accumulated 1152 with data that was previously prefetched from answer buffer 1160.

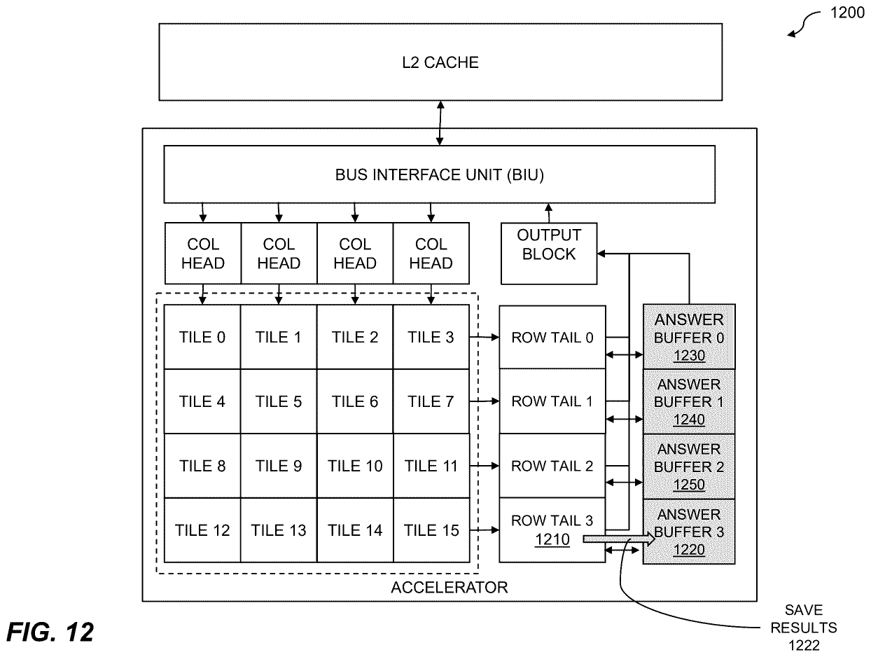

FIG. 12 is a sixth block diagram of row tail function. The block diagram 1200 is based on the block diagram of row tail function shown in FIG. 7 and described previously. Accordingly, components in FIG. 12 are similar to counterpart components shown in FIG. 7. FIG. 12 shows the block diagram of FIG. 11, at a subsequent clock cycle. As shown in block diagram 1200, row tail 3 1210 updates answer buffer 3 1220 with partial product information via save operation 1222. At this point in the execution of the systolic array, each answer buffer 1230, 1240, 1250, and 1220 contains partial product information that can represent a final 32×32 matrix-multiply answer.

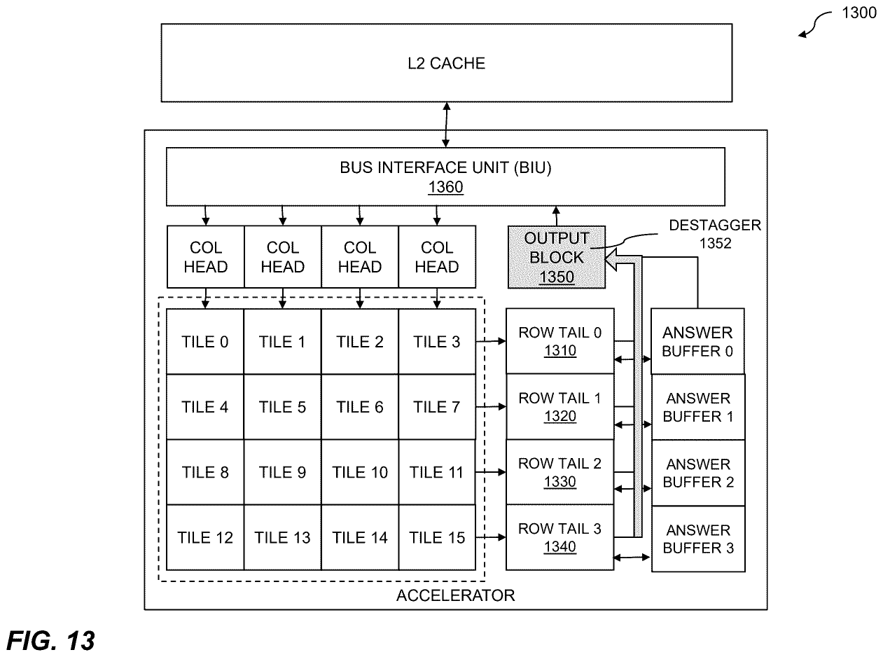

FIG. 13 is a seventh block diagram of row tail function. The block diagram 1300 is based on the block diagram of row tail function shown in FIG. 7 and described previously. Accordingly, components in FIG. 13 are similar to counterpart components shown in FIG. 7. FIG. 13 shows the block diagram of FIG. 12, at a subsequent clock cycle. As shown in block diagram 1300, the results from each row tail 1310, 1320, 1330, and 1340 are provided to output block 1350, thereby performing a destagger operation 1352 on the temporally staggered partial products. The output block can provide destaggered answer information to the bus interface unit (BIU) 1360. The output block can reconvert the data format from a quintuple format back to a first format. Thus, embodiments can include reconverting, by an output block, a final answer to the first data format. The first data format can include formats such as FP-16, BF16, MXFP8, MXFP6, MXFP4, INT8, and/or other suitable formats.

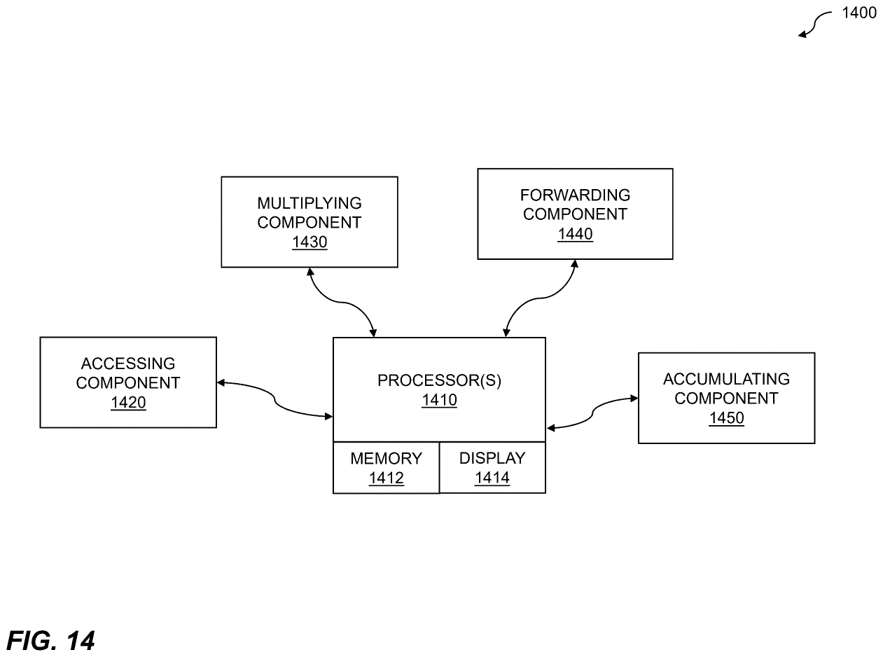

FIG. 14 is a system diagram for a systolic array matrix-multiply accelerator with row tail accumulation. The system 1400 can include instructions and/or functions for design, generation of semiconductor logic for, and implementation of, integrated circuits that support a systolic array matrix-multiply accelerator with row tail accumulation. The system 1400 can include instructions and/or functions for generation and/or manipulation of design data such as hardware description language (HDL) constructs for specifying structure and operation of an integrated circuit. The system 1400 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

In disclosed implementations, semiconductor logic generation can be accomplished using hardware description languages (HDLs) such as Verilog or VHDL. These languages allow designers to specify digital circuits at the register transfer level (RTL), describing how signals flow between registers and how logical operations are performed. The HDL source code can be compiled and synthesized into gate level netlists that represent the actual semiconductor logic structures. At the RTL stage, disclosed implementations can capture both functional behavior and timing relationships. RTL descriptions are processed by synthesis tools that map the abstract operations into specific logic gates, flip flops, and interconnect structures. This process can enable automated generation of semiconductor logic that can be implemented in silicon, while preserving the intended arbitration and control functions originally specified. One or more implementations may include simulation of the HDL or RTL code prior to synthesis. Simulation environments allow verification of functional correctness, timing behavior, and corner cases. By running testbenches against the HDL code, designers can confirm that arbitration logic operates as intended before committing to gate level synthesis. Simulation also provides visibility into signal waveforms and processor request interactions, ensuring that the arbitration criteria are correctly enforced. One or more implementations may further involve common file formats used in the semiconductor design flow. HDL source files are typically stored in plain text formats (.v, .vhd), while synthesized netlists may be represented in formats such as EDIF or Liberty. Layout data is often exchanged in GDSII or OASIS formats. These standardized formats enable interoperability across tools and vendors, and support error checking during import/export. Error checking can be an integral part of the flow. One or more implementations may include automated linting tools that detect undeclared signals, mismatched bit widths, or unused variables in HDL code. During synthesis and layout, design rule checks (DRC) and layout versus schematic (LVS) checks confirm that the generated semiconductor logic adheres to fabrication constraints and matches the intended design. One or more implementations may also address conflicts that arise in visualization and reporting. For example, waveform viewers and schematic generators may use color coding to distinguish signals, buses, and states. Conflicts in color assignments or overlapping graphical elements can obscure analysis. Tools therefore include configurable color palettes and conflict resolution mechanisms to ensure clarity in simulation results and design documentation. Finally, once synthesized and verified, the gate level netlist undergoes optimization and placement/routing to produce a physical layout suitable for fabrication. The resulting semiconductor logic embodies the arbitration mechanisms described in the HDL, ensuring that processor requests are managed according to dynamically assigned criteria. This tool-based flow demonstrates how software code can be transformed into concrete semiconductor logic structures, providing enabling support for claims directed to logic generation.

The system 1400 can include one or more of processors, memories, cache memories, displays, and so on. The system 1400 can include one or more processors 1410. The processors can include standalone processors, processors within integrated circuits or chips, processor cores in FPGAs or ASICs, and so on. The one or more processors 1410 are coupled to a memory 1412, which stores instructions. The memory can include one or more of local memory, cache memory, system memory, etc. The system 1400 can further include a display 1414 coupled to the one or more processors 1410. The display 1414 can be used for displaying data, instructions, operations, multiply-accumulate computations, matrix multiplication computations, and the like. The operations can include instructions and functions for implementation of integrated circuits, including processor cores and/or accelerators. In exemplary implementations, the processor cores can include RISC-V™ processor cores that are configured to interact with an accelerator via an L2 cache within a memory hierarchy. In exemplary implementations, the accelerator can include a systolic array matrix-multiply accelerator with row tail accumulation. A system comprising the one or more processors 1410, when executing the instructions which are stored in the memory 1412, is configured to enable operation with a systolic array matrix-multiply accelerator with row tail accumulation.

The system 1400 can include an accessing component 1420. The accessing component 1420 can include functions and instructions for accessing an accelerator, wherein the accelerator includes a systolic array of tiles comprising a plurality of rows and a plurality of columns, wherein each tile in the systolic array of tiles comprises one or more multiply-add units, and wherein the accelerator includes a row tail associated with each row within the plurality of rows. The row tails of disclosed implementations can include circuitry, logic, functions, microcode, and/or other elements for implementing efficient multiply-accumulate operations within a row of tiles.

The system 1400 can include a multiplying component 1430. The multiplying component 1430 can include functions and instructions for multiplying, by the systolic array, a first matrix by a second matrix, wherein the multiplying is based on a plurality of partial products, and wherein a row within the plurality of rows of the systolic array produces one or more partial products within the plurality of partial products. In exemplary implementations, the multiplying is accomplished by a systolic array comprising a plurality of rows, where each row of the plurality of rows is coupled to a corresponding row tail.

The system 1400 can include a forwarding component 1440. The forwarding component 1440 can include functions and instructions for forwarding, by a last tile within the row, to an associated row tail, the one or more partial products. The partial products can be represented in quintuple format. The quintuple format can comprise fields that include a 1-bit valid, 1-bit sign, 9-bit (signed) exponent, an 8-bit unsigned significand, and a 2-bit status field.

The system 1400 can include an accumulating component 1450. The accumulating component 1450 can include functions and instructions for accumulating, by the associated row tail, the one or more partial products that were forwarded, with one or more previous partial products associated with the row. The previous partial products can be based on a previous activation matrix, bias matrix, input matrix, and/or other types of matrices.

The system 1400 can include a computer system for matrix processing comprising: a memory which stores instructions; one or more processors coupled to the memory wherein the one or more processors, when executing the instructions which are stored, are configured to: access an accelerator, wherein the accelerator includes a systolic array of tiles comprising a plurality of rows and a plurality of columns, wherein each tile in the systolic array of tiles comprises one or more multiply-add units, and wherein the accelerator includes a row tail associated with each row within the plurality of rows; multiply, by the systolic array, a first matrix by a second matrix, wherein the multiplying is based on a plurality of partial products, and wherein a row within the plurality of rows of the systolic array produces one or more partial products within the plurality of partial products; forwarding, by a last tile within the row, to an associated row tail, the one or more partial products; and accumulate, by the associated row tail, the one or more partial products that were forwarded, with one or more previous partial products associated with the row.

The system 1400 can include a computer program product embodied in a non-transitory computer readable medium for matrix processing, the computer program product comprising code which causes one or more processors to generate semiconductor logic for: accessing an accelerator, wherein the accelerator includes a systolic array of tiles comprising a plurality of rows and a plurality of columns, wherein each tile in the systolic array of tiles comprises one or more multiply-add units, and wherein the accelerator includes a row tail associated with each row within the plurality of rows; multiplying, by the systolic array, a first matrix by a second matrix, wherein the multiplying is based on a plurality of partial products, and wherein a row within the plurality of rows of the systolic array produces one or more partial products within the plurality of partial products; forwarding, by a last tile within the row, to an associated row tail, the one or more partial products; and accumulating, by the associated row tail, the one or more partial products that were forwarded, with one or more previous partial products associated with the row.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products, processor-implemented methods, and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for matrix processing comprising:
accessing an accelerator, wherein the accelerator includes a systolic array of tiles comprising a plurality of rows and a plurality of columns, wherein each tile in the systolic array of tiles comprises one or more multiply-add units, and wherein the accelerator includes a row tail associated with each row within the plurality of rows;
multiplying, by the systolic array, a first matrix by a second matrix, wherein the multiplying is based on a plurality of partial products, and wherein a row within the plurality of rows of the systolic array produces one or more partial products within the plurality of partial products;
forwarding, by a last tile within the row, to an associated row tail, the one or more partial products; and
accumulating, by the associated row tail, the one or more partial products that were forwarded, with one or more previous partial products associated with the row.

2. The method of claim 1 further comprising matching the associated row tail with an answer buffer.

3. The method of claim 2 wherein the answer buffer that was matched with the associated row tail comprises two or more static random-access memory (SRAM) banks, wherein each SRAM bank within the two or more SRAM banks includes a single port, wherein the answer buffer is capable of reading and writing on a single clock cycle.

4. The method of claim 2 wherein the accumulating includes prefetching, by the associated row tail, from the answer buffer, the one or more previous partial products associated with the row.

5. The method of claim 4 further comprising forcing the one or more previous partial products to zero, wherein the forcing is based on one or more control bits.

6. The method of claim 4 further comprising storing, by the associated row tail, a result of the accumulating, wherein the storing is accomplished by the answer buffer.

7. The method of claim 1 further comprising sending, to an output block, by the associated row tail, a result of the accumulating.

8. The method of claim 7 wherein the sending includes a second associated row tail associated with a second row within the plurality of rows, and wherein the sending includes a second result of the accumulating.

9. The method of claim 8 wherein the sending is staggered between the associated row tail and the second associated row tail, wherein the staggering is based on a clock cycle of the accelerator.

10. The method of claim 9 further comprising destaggering, by the output block, the result of the accumulating and the second result of the accumulating, wherein the destaggering results in a final answer.

11. The method of claim 1 wherein the first matrix comprises a weight matrix, and wherein the second matrix comprises an activation matrix.

12. The method of claim 11 wherein the multiplying includes a product of a third matrix and the first matrix.

13. The method of claim 12 wherein the third matrix comprises a second activation matrix.

14. The method of claim 1 wherein the multiplying, the forwarding, and the accumulating include one or more additional rows.

15. The method of claim 1 wherein the first matrix and the second matrix comprise floating-point data, wherein the floating-point data is based on a first data format.

16. The method of claim 15 wherein the first data format comprises a brain floating-point 16 (BF16) format.

17. The method of claim 16 wherein each row within the plurality of rows comprises a stream of eight BF16 format partial products.

18. The method of claim 16 further comprising converting the floating-point data from the first data format to a quintuple format.

19. The method of claim 18 wherein the accumulating includes normalizing the one or more partial products that were forwarded.

20. The method of claim 19 further comprising reconverting, by an output block, a final answer to the first data format.

21. The method of claim 1 further comprising receiving, by the accelerator, a work request from a processor core, wherein the work request includes the first matrix and the second matrix.

22. A computer program product embodied in a non-transitory computer readable medium for matrix processing, the computer program product comprising code which causes one or more processors to generate semiconductor logic for:
accessing an accelerator, wherein the accelerator includes a systolic array of tiles comprising a plurality of rows and a plurality of columns, wherein each tile in the systolic array of tiles comprises one or more multiply-add units, and wherein the accelerator includes a row tail associated with each row within the plurality of rows;
multiplying, by the systolic array, a first matrix by a second matrix, wherein the multiplying is based on a plurality of partial products, and wherein a row within the plurality of rows of the systolic array produces one or more partial products within the plurality of partial products;
forwarding, by a last tile within the row, to an associated row tail, the one or more partial products; and
accumulating, by the associated row tail, the one or more partial products that were forwarded, with one or more previous partial products associated with the row.

23. A computer system for matrix processing comprising:
a memory which stores instructions;
one or more processors coupled to the memory wherein the one or more processors, when executing the instructions which are stored, are configured to:
access an accelerator, wherein the accelerator includes a systolic array of tiles comprising a plurality of rows and a plurality of columns, wherein each tile in the systolic array of tiles comprises one or more multiply-add units, and wherein the accelerator includes a row tail associated with each row within the plurality of rows;
multiply, by the systolic array, a first matrix by a second matrix, wherein the multiplying is based on a plurality of partial products, and wherein a row within the plurality of rows of the systolic array produces one or more partial products within the plurality of partial products;
forward, by a last tile within the row, to an associated row tail, the one or more partial products; and
accumulate, by the associated row tail, the one or more partial products that were forwarded, with one or more previous partial products associated with the row.
